(19) United States
(12) Patent Application Publication
(10) Pub. No.: US 2006/0010035 A1
(43) Pub. Date: Jan. 12, 2006

(54) Personal document creation

(76) Inventors: Keiron Allen, London (GB); Alexander Krzeczunowicz, London (GB); Martin Redington, London (GB); Neil Forrester, Brighton (GB); Adam Neilson, London (GB); Michael Paull, London (GB); Martyn Pocock, Rutland (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/889,196

(22) Filed: Jul. 12, 2004

(51) Int. Cl. G06Q 30/00

(52) U.S. Cl. 705/14

(57) ABSTRACT

A computer-implemented method and system for providing targeted information to a recipient of a personal document by generating the document containing personal information from a first source and promotional information from a second source after selecting the personal document recipient for receiving the promotional information from the second source in dependence on the personal information. Typically, the document will be a payslip and the recipient an employee. Also provided is a computer-implemented engine for managing the personal document providing service, the engine having an interface for receiving personal information; an interface for receiving promotional information; and, a processing system adapted to select the personal document recipient for receiving promotional information in dependence on the personal information, the processing system further adapted to generate data for producing the personal document.

### CROSS-REFERENCE TO RELATED APPLICATIONS

Not applicable.

### BACKGROUND OF THE INVENTION

1. The Field of the Invention

The present invention relates to the provision of targeted information and advertising within personal documents, and payslips in particular.

2. The Relevant Technology

In the modern world, where consumers are more discerning and commercially aware, advertisers are continually looking for new and more targeted ways to reach their audience. Although the mainstay technique of blanket advertising using mass media communications can ensure a widespread audience, it can also be prohibitively expensive and is difficult to target at a particular population group and to obtain feedback on its impact.

More specific advertising is often employed by organizations who regularly contact their customers by conventional mail or, increasingly, by electronic mail and mobile telephony. Examples include utility companies, banks and credit card companies, where the advertising usually relates to their own products or those of providers with whom they have an arrangement. Typically, the advertising takes the form of loose-leaf fliers, which accompany the main correspondence or, in the case of electronic correspondence, an electronic attachment. Some credit card companies now include advertisements printed on the actual customer bill, to increase the likelihood that the customer will read them.

A more recent development is the inclusion of advertising material within an employee's payslip. Again the enclosed information is separate from the actually payslip. In this instance, the employer is likely to be a large publically funded body, such as a local authority or a university. For an agreed fee, the organization allows third parties to supply marketing material for inclusion with the payslips, thereby reaching a large “captive” audience. Of course, any such organizations must operate within the confines of local data protection legislation, and withhold personal information if requested to do so by an employee.

However, despite these evolutions in targeted advertising, the marketing remains indiscrimatory, both in terms of the subject matter and the make-up of the particular population group receiving the advertising matter. Thus, there is a strong motivation for a mechanism by which third parties can reach selectively targeted groups of people with specifically designed advertising and informative material concerning products and services in which they may be interested and which are attuned to their financial and personal situation.

### BRIEF SUMMARY OF THE INVENTION

According to a first aspect of the present invention, a computer-implemented method for providing targeted information to a recipient of a personal document comprises the steps of:
receiving personal information from a first source for inclusion in the personal document, the personal information concerning the recipient of the personal document;
selecting the personal document recipient for receiving promotional information from a second source in dependence on the personal information;
receiving promotional information from the second source for inclusion in the personal document; and,
generating the personal document containing the personal information and the promotional information.

Preferably, the personal document is a payslip and the recipient is an employee. Alternatively, the personal document may be a benefit statement, a pension statement or other form of important notification.

Preferably, the personal information is selected from a group which includes salary, taxed income, profession, age, sex, pension contribution and postcode of the intended recipient.

In general, the promotional information from the second source will be completely predetermined. However, on selection of the recipient, the promotional information may be personalized to the recipient.

In this manner, an important personal document may be generated that includes not only the necessary identifying and other primary information intended for the recipient but also additional promotional information targeted at the recipient in dependence on their personal information. The source of the personal information will generally be the employer, government department, pension company and the like, or else their agent or intermediary. The source of promotional information will usually be a company or organization wishing to advertise their products or services, or else an intermediary acting on their behalf.

Preferably, the method further includes the step of receiving internal communications and/or promotional information from the first source for inclusion in the personal document. Preferably, the internal communication and/or internal promotional information is selected in dependence on the personal information. This feature allows an employer, for example, to include their own targeted informative or advertising material within a payslip document.

Of course, promotional information may be supplied by and received from a plurality of advertising sources for inclusion in the personal document. Therefore, the step of selecting the recipient will preferably comprise the step of allocating the recipient to one or more advertising sources for the purpose of determining which promotional information is to be included in the personal document. The allocation process will preferably be mediated by an allocation strategy.

Prior to the allocation step, the process may further comprise a reservation step, whereby an advertising source can place one or more reservations for particular groups of recipients who have been selected for particular targeted advertising. The reservation process will preferably be mediated by a reservation strategy.

Advertisers will select their preferred target audience on the basis of certain criteria. The primary source of information, which may be made available to advertisers subscribing to the system, will typically be the personal information to be included in the personal document. However, the process will preferably include a query step, whereby an advertiser may place a query with the service provider to determine whether a suitable target audience exists based on their chosen criteria. The response will preferably comprise aggregate information, with the identity and details of potential recipients remaining undisclosed. The query process will preferably be mediated by a search strategy.

In order to facilitate the search, reservation and allocation processes, the service provider will preferably compile a database of information relating to the recipients of the personal documents and pertinent to the needs of potential advertisers. In addition to the primary personal information sources available, the service provider may garner further information directly from the end recipients via questionnaires and the like. The recipient may receive some form of recompense for returning a completed personal information and/or preference questionnaire.

As described above, the personal document will typically be generated in paper form. Advantageously, however, the personal document may be generated in electronic form. An electronic document can be sent by e-mail, mobile telephony and the like or accessed via the internet. Furthermore, electronic attachments can be included, such as passive informative or advertising material or else some form of active multimedia presentation. Another advantage of the electronic form is that software application packages may be bundled with the electronic document and may be interactively linked to it. For example, personal financial software to aid personal budgeting or to facilitate the completion and filing of tax returns.

According to a second aspect of the present invention, a personal document providing service implements the method according to the first aspect of the present invention.

According to a third aspect of the present invention, a computer-implemented engine for managing a personal document providing service comprises:
an interface for receiving personal information from a first source for inclusion in a personal document, the personal information concerning an intended recipient of the personal document;
an interface for receiving promotional information from a second source; and,
a processing system adapted to select the personal document recipient for receiving promotional information from the second source in dependence on the personal information, the processing system further adapted to generate personal information data and promotional information data for producing the personal document.

Preferably, the interface for the second source is adapted to receive recipient selection data from the second source. Preferably, the engine further comprises an interface for receiving preference data from the personal document recipient.

For ease of access, it is preferred that an engine management interface is are web enabled, allowing operations via the internet.

In managing the service it is preferred that the processing system of the engine is further adapted to execute query, reservation and allocation processes mediated by corresponding search, reservation and allocation strategies. In this way the engine can manage the competing preferences and requirements of a plurality of advertising sources.

In order to execute the query, reservation and allocation steps efficiently, it is preferred that the engine is coupled to a database storing personal and preference information relating to the intended personal document recipients.

### BRIEF DESCRIPTION OF THE DRAWINGS

Examples of the present invention will now be described in detail with reference to the accompanying drawings, in which:

FIG. 1 shows a typical employee payslip;

FIG. 2 shows a payslip containing internal and promotional information in accordance with the present invention;

FIG. 3 shows examples of internal benefit packages that may be advertised in a payslip;

FIG. 4 illustrates a targeted information system for producing the payslip of FIG. 2; and

FIG. 5 shows examples of the allocation of a target audience to two advertisers.

### DETAILED DESCRIPTION OF THE PREFERRED EMBODIMENTS

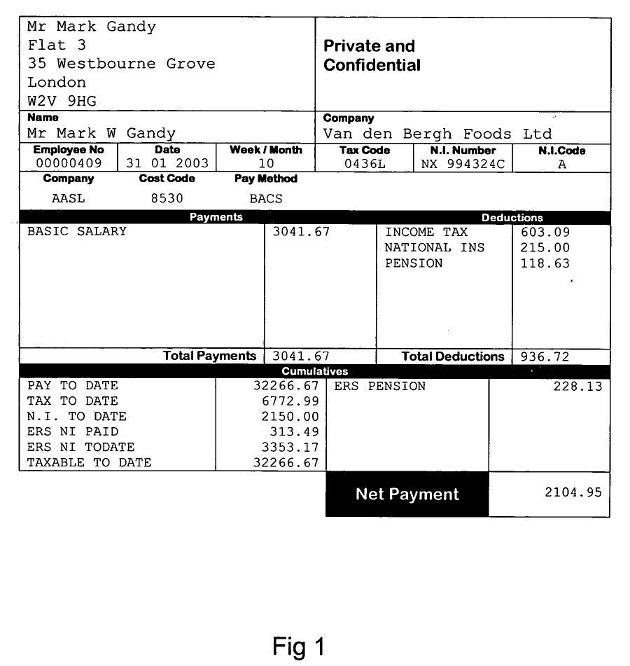

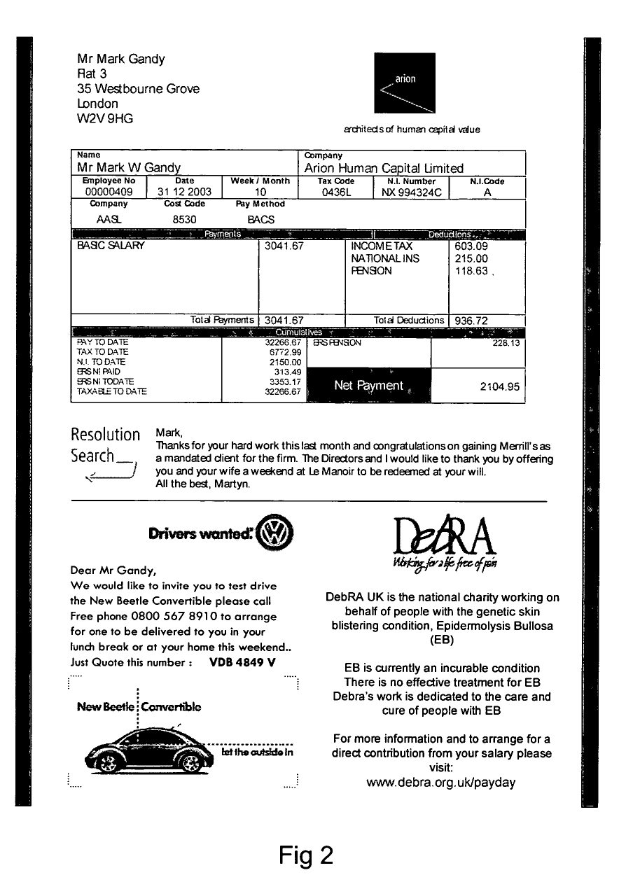

Existing personal information documents tend to be bland, monochrome, factual documents, such as the payslip shown in FIG. 1. Nevertheless, they display useful information, including name, address, postcode/zip code, company name, employee number, tax code, national insurance/social security code, sex and most importantly salary information. The present invention, known by the trade mark “Payday”, uses this information to allow advertisers to target advertising directly to an employee's payslip, or other personal document. FIG. 2 shows an example of what a Payday payslip might look like. It is emphasised that, although a payslip is the prime target of the Payday system, the concept can easily be extended to a range of personal documents, including benefit statements and pension statements.

There are three key problems that marketers face that Payday helps to resolve. Firstly, while marketers may send thousands of pieces of direct mail, there is no guarantee that the recipients will actually open and read it. Secondly, while mailing lists help to group and target a target audience, there is no guarantee that the information is accurate and up to date. Finally, even with such targeted advertising, the marketer has no sense of how a recipient feels financially when they receive their message.

Payday addresses each of these problems because a large majority of people open and read their payslips and because a payslip is an accurate, up-to-date document that has valuable targeting information on it, including salary, postcode, profession and a list of benefits. It is very unlikely that a payslip will be sent to the wrong address because someone has moved. Furthermore, the one thing a marketer can be guaranteed of when advertising via a payslip is that the recipient has been paid. The employee has money and is more likely to be receptive to appropriately targeted advertising.

In exploiting the concept of Payday, there are at least the following four key areas to be considered: advertising, internal communications, branding and enhanced benefits packages. Each of these will now be considered with reference to the example shown in FIG. 2.

Payslip advertising can benefit both the advertiser and the recipient organization/individual. From the perspective of the advertiser, they can make a targeted enquiry using salary, profession, age, sex and postcode as search criteria; create or submit an advert to send to their selected audience; pay for that advert or place an advance booking (pre-book) for the future; and, finally, the production and delivery of the payslip is done for them. From the perspective of the employer/employee, they can request particular kinds of messages from advertisers e.g. holiday offers or car offers, and deny particular brands from advertising to them.

Internal communications between employer and employee are facilitated. An employer will be able to send individual or group messages to people on their payslips. These may relate to work issues, remuneration or activities/issues external to work. An example is shown in the middle section of FIG. 2, where an employee is being individually rewarded for recent work-related performance.

Frequently, payslips have a generic format, which is therefore not specific to a particular company using them. This is especially true when provided by a third party supplier. A consequence of the personalization offered by the Payday system is that a particular branding can easily be applied to a payslip. Employers will be able to brand their payslips and design the payslip in terms of logo, design, font and colour. Such corporate personalization is illustrated in the example payslip shown in FIG. 2.

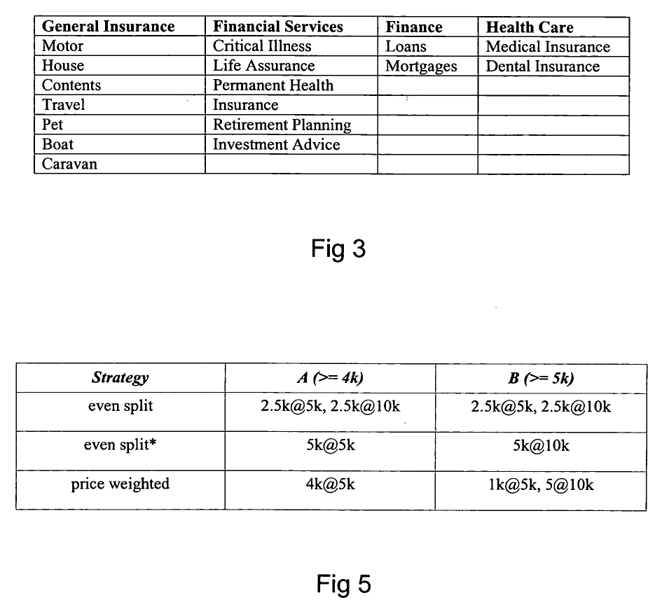

The concepts of advertising and internal communications can be combined in the form of internal advertising by the employer. A particular example is an enhanced benefits package which may be offered to employees. Payday will enable employers to advertise employee benefit packages to their staff through the internal communication section of the payslip. FIG. 3 lists many of the different types of benefits that may be made available to the employee. Some or all of these options may be enabled by a web-interface.

Thus far, the description of the present invention has centered on paper documents, but other innovative attributes of the Payday system are envisaged, such as in the application to digital payslips. Digital payslips already exist, but the ability to create an advertising market around them does not. In its simplest electronic embodiment Payday can easily provide a static version of the digital payslip, which will look similar to the physical one. However, electronic documentation offers a wealth of other possibilities such as televisual advertising securely attached to the digital slips. This will give the payslip all the benefits of digital marketing but with none of the doubts.

Payslips are usually collected by employees at the workplace. In contrast, Payday offers people the choice of delivery address, including both the home and the office. The provision of this choice is an important feature for many western societies, as the household earner is often different from the household spender, a situation particularly identifiable in Japan. The home delivery of payslips allows for the possibility of bundling other related material, such as a free home accounting package that can tie-in tax and revenue information with the payslip alongside household expenditure and investments, thereby facilitating the completion of tax returns and even their automatic filing. The functionality of this type of system can, of course, be significantly enhanced where the payslip is provided in a digital format.

A further embellishment that is envisaged is the provision of a region explaining tax deductions. There are many motivating reasons for providing this aspect, not least that it is likely to increase readership of the payslip and therefore any advertising included in it. The amount of tax taken each month is most likely seen as an annoyance by the employee, but has little other meaning to them. However, an analogy can be drawn with the employer-employee relationship. An employee's salary is the recompense the company gives to an employee for the services they have rendered. With this principle in mind, national insurance (NI) contributions and pay-as-you-earn (PAYE) deductions are the recompense with which a member of the state rewards the state for the services and security they have received from it. A key difference between these otherwise analogous situations is that, while in one case a party is directly accountable, in the other case the level of accountability is minimal. Governments are only elected every few years, and this is normally decided on by party and premier not by issue and policy. Therefore, as a result of consumer research, Payday proposes to break down the tax payment as displayed on a payslip into the key areas of government expenditure, by using publicly available statistics from the National Audit Office. Thus someone who pays a £1,000 in tax a month might find that proportionately £230 is spent on the health system (NHS), £280 on defense, £130 on education and so on.

The use of consumer research has already been alluded to in relation to the formulation of one of the features of Payday. However, such research can actually be included in the overall Payday system, for enhanced targeting and profiling of employees. Employee paid surveys can be generated to build a more detailed targeting database. This innovation borrows from the world of media research, in particular the Target Group Index (TGI) system. TGI pays respondents to fill in questionnaires that detail their shopping and media behaviour, in addition to psychographic questionnaires. The resulting database allows for very detailed clustering analyses. However, using current systems, an advertiser can not automatically send an appropriate communication direct to the actual people who have filled in the questionnaires. Payday offers a system that links this targeting information direct with the advertisers who wish to communicate with the respondents.

Following the above discussion, the key attributes of the Payday system can be summarized as follows:
Searching of payslip audience
Creation and placement of advertising
Targeted advertising on a physical payslip
Targeted advertising on a digital payslip
Explanation and breakdown of tax payments
Branded payslips
Enhanced targeting and profiling through employee paid surveys
Individual and group wide internal communications
Payslips being delivered direct to home
Targeted advertising on benefit statements
Targeted advertising on pension statements

We now consider in more detail the actual architecture for implementing the Payday system, beginning with an overview. The Payday application co-ordinates the selling and distribution of advertising space between parties who have no direct contact with one another. In the context of advertising on payslips, those parties will typically be an advertiser, an employer and a set of employees. It is noted that here the “advertiser” is considered to include not only the ultimate client but also any intervening agencies, marketing organizations and the like. At the highest level, the inputs and outputs to and from the system are as follows:
(i) advertiser supplies the advertising and the targeting criteria
(ii) employer supplies employee and payroll data
(iii) employee supplies opt-in and advertising preference data

The system has printing instructions for a set of payslips, with appropriate payroll information and advertising messages for each employee. Employee responses to the advertisements are not mediated directly by the system, although response information may be captured and fed into the system for reporting back to the advertiser.

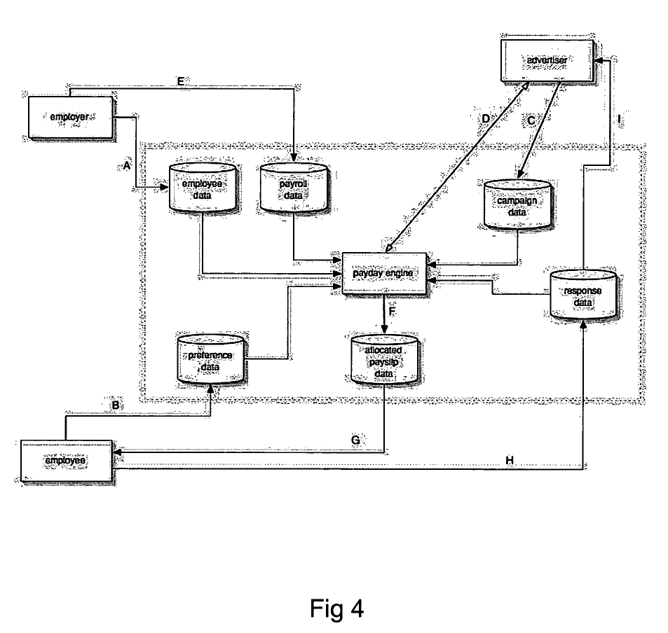

To illustrate the functioning of the Payday application we now consider the architecture of the system. FIG. 4 illustrates the key elements in a high level view of the system, with the main interactions indicated by arrows which are labeled alphabetically [A-I] and cross-referenced in the steps listed below. For clarity, only a subset of important features are shown here. The key steps in the process are:

(1) A set of one or more employers join the service, and they, or their agents, provide identifying information (e.g. employee numbers and national insurance numbers) about their respective sets of employees [A].

(2) The employers also provide preference information about the kinds of adverts they would prefer, or object to their employees receiving.

(3) The employers (or their agents) also provide payroll dates for their company.

(4) The employers (or their agents) also provide the layout and design of the “payroll” section of the payslip, and any branding that is to be applied.

(5) Accounts are created on the system for each employee, and they are invited to opt-in to the service, to provide further information about themselves and their interests, and to set their preferences as to what kind of adverts they would like or not like, to receive [B].

(6) A set of advertisers join the service.

(7) Advertisers can create “campaigns”. A campaign is an informational or promotional message, intended to be delivered to the employees whose employers have signed up to the service, and who have opted in. The campaign has a set of associated artwork and copy, which make up the actual message, and a set of categories, indicating the nature of the product or services that it relates to [C].

(8) The advertiser can browse the available target audiences (of employees) specifying characteristics such as age, sex, income, industry sector, geographical location and the like. This is the query process [D].

(9) When a suitable audience is located, the advertiser can book or reserve the audience for a particular campaign. One or more audiences can be associated with the campaign. This is the reservation process [D].

(10) The campaign can now be “published”. The materials and categories for the campaign will be vetted for suitability by Payday staff.

(11) Payments due for the campaign are calculated according to the pricing model and are collected from the advertiser.

(12) The employers (or their agents) supply the final payroll data for the relevant current period [E].

(13) Optionally, the employers also supply informational messages to be delivered on the payslip (internal communications).

(14) The payslips for each employee are generated containing a) the employees pay data, b) the internal communications message provided by the employer, and c) one or more advertisements corresponding to the campaigns supplied by the advertisers [F].

(15) The assignment of particular adverts to particular payslips takes into account the preferences provided by the employer and employee, the employees previous responses, the targeting criteria for the campaign provided by the advertiser, and the price which can be charged for the target population or individuals. This process is termed allocation.

(16) After allocation, the target audience (the numbers reserved by the advertiser) and the achieved audience (the audience who were eventually allocated the relevant advert) are compared, and any refunds due from a shortfall are credited back to the advertiser.

(17) The payslips are printed and distributed to the employees [G].

(18) Employees are given the opportunity (for example, through a web-based interface) to review the adverts they have received and to respond to those adverts, or provide feedback on the advert and indicate whether or not they would like to receive similar adverts in the future. This data is stored with their preferences data.

(19) Employees may also respond to the advert directly. Where possible, such responses, whether by phone, email, or over the world wide web, are captured or logged and the data fed back into the system [H].

(20) Appropriate reporting data (e.g. response rates) is presented to the advertiser [I].

As described, the Payday process has been presented as occurring in a linear sequence. In practice, however, the process would be continuous in a real operational system. Furthermore, many variations are possible. For example, although the terms “employers”, “employees”, and “payslips” are used here, the system could be applied in any context where an organization or corporation has permission or an obligation to distribute media to a set of individuals. A specific example is a pension company, which could use the system to sell space on the pension statements that they issue to their pension holders. Pricing models, for determining charges to the advertiser(s), might be based on the number of employees targeted, with a premium being charged for more tightly targeted criteria, or for targeting employees with higher spending power. Additional premiums could be charged in return for increasing the certainty that an advertiser would actually obtain the desired audience, or else audiences could be priced via an auction process.

As shown in FIG. 4, a key component of the Payday system is the computer-implemented Payday engine. The Payday engine is responsible for the query, reservation, and allocation processes identified above. The engine has access to at least the following information:
(i) the employer sectors and advertising preferences.
(ii) employee data, opt-in status, demographic and interest data, advertising preferences, and response history.
(iii) the payroll dates for the employees.

The query process takes the advertiser's criteria as its input, and returns zero or more sets of employees who provide a reasonable match to those criteria. In general, only aggregate information about the audience sets is returned. The query is guided by a search strategy. Different strategies may be appropriate in different markets or contexts, and it is anticipated that a range of different strategies will be available, and which can be activated or “plugged-in” as appropriate. Strategies may also be tunable.

As an illustration, consider the case where advertisers often reserve audiences, only later to abandon their plans. A conservative search strategy, that only identified audiences as available if they were currently unreserved, would underestimate the audience that would actually be available at allocation. Conversely, a reckless strategy that always considered employees to be available, even if there were existing reservations, would overestimate the available audience. Somewhere between the two extremes is a point where the number of advertisers who are able to reserve the audiences they desire and the number of advertisers whose reservations cannot ultimately be fulfilled can be traded off in an appropriate manner. Such a trade off can be modeled by an optimization function that may also take into account other factors, such as the status of the advertiser (in terms of their value as a customer).

Similarly, consider a case where many employees express strong preferences about the kind of advertising they are not willing to receive. If the search strategy does not take these preferences into account, then it will consistently overestimate the available audiences for unpopular adverts. Alternatively, if only a few employees express strong preferences, then the search strategy might ignore such preferences altogether, thereby increasing the speed of the search.

The reservation process takes an advertiser's criteria and, if possible, “ireserves” a corresponding target audience. Reservation is optimistic. Specific individual employees are not necessarily identified at this point. Instead, as with query, various relevant factors are traded off according to an appropriate reservation strategy. The reservation strategy will generally be similar, if not identical to, the search strategy employed for querying, although it may take into account other or additional factors, such as the users response to prior campaigns, pricing and predicted audience.

Finally, the allocation process is where reservations are mapped to specific employee payslips. As with the query and reservation processes, allocation is guided by an allocation strategy. The strategy is similarly guided by competing concerns and will attempt to trade these off for the benefit of all concerned. The strategies would be both pluggable and tunable, in order to fit particular contexts. However, because the allocation has definite real-world consequences, and because the constraints on allocation are slightly different (e.g. because allocation is an offline process, time pressure may be lower, and allocation potentially must take more account of the entire set of active reservations), it is expected that allocation strategies may be considerably more sophisticated than search or reservation strategies. Different strategies may embody different algorithms and computational processes for discovering the “optimal” allocation.

By way of illustration, consider the case where the available population of employees is 10,000, and consists of only two categories of employees, 5,000 employees who earn 5,000 pounds a year and 5,000 employees who earn 10,000 pounds per year. Two advertisers (A & B) each make a reservation for 6,000 employees. Advertiser A has the criteria that the employees must earn 4,000 pounds or more per year. Advertiser B has the criteria that the employees must earn 5,000 pounds or more a year. As illustrated in FIG. 5, there are a number of ways that the employees could be allocated to the advertisers. In the “even split” strategy, the available population is simply split equally between the advertisers, who each reach an expected audience of 5k, all of whom satisfy their target criteria. In this case both advertisers experience a shortfall of 1k on their original target. In the “even split*” strategy, the overall number of employees are again apportioned equally to each advertiser, but advertiser A receives the 5,000 employees earning 5K, whereas advertiser B, who under a specific pricing model may be charged more for targeting employees with a higher spending power or may be an especially favoured customer, receives a benefit in terms of being allocated employees with a higher spending power (10K). As before, both advertisers experience a shortfall of 1,000 on their original reservation. Lastly, in the price weighted strategy, Advertiser B, who is either paying a higher rate per employee or is favoured in some other way, is allocated 6,000 employees, and their reservation is satisfied in full. Advertiser B receives the remaining 2,000 employees, suffering a shortfall of 4000 on its original request.

The specific allocation strategy that is selected, and the settings of the parameters for the strategy, should be determined according to the tradeoffs that are relevant to the business and its customers. For strategy selection, these might include the cost in development and the processing resources of a particular allocation strategy, as well as the quality of the allocations it produces. For parameter setting (tuning), these will include: the cost of disappointing specific advertisers or classes of advertisers (i.e. being unable to honor some or all of their reservations); the need to send to employees adverts of the kind they may have indicated a positive preference for; the employees' previous response rates to adverts of the same kind and the impact that variations in response rate will have on advertisers' willingness to reuse the service; the pricing model in operation; and, the expected revenue.

It is anticipated that allocation strategies may be considerably more sophisticated and complex than the very simple illustrations given above. For example, a sophisticated allocation strategy might use a genetic algorithm approach, encoding allocations for a specific set of adverts and employees as a digital “genome”. A mathematical “fitness function” measures the degree that a particular allocation satisfies the various constraints of the kind described above. Randomly generated (or best guess) initial genomes can be “evolved”, by combining them randomly and proportionally selecting the offspring for further breeding according to their fitness. Over generations, the fitness of the allocation (i.e. the extent to which it jointly optimizes the various constraints) will increase. The parameters for this particular strategy would include the specific fitness function chosen, the method for selecting the initial genomes (allocations), and the specifics of the replication and selection processes. Of course, alternative strategies might use entirely different computational techniques.

What is claimed is:

1. A computer-implemented method for providing targeted information to a recipient of a personal document comprising the steps of:
receiving personal information from a first source for inclusion in the personal document, the personal information concerning the recipient of the personal document;
selecting the personal document recipient for receiving promotional information from a second source in dependence on the personal information;
receiving promotional information from the second source for inclusion in the personal document; and,
generating the personal document containing the personal information and the promotional information.

2. The method according to claim 1, in which the personal document is a payslip and the recipient is an employee.

3. The method according to claim 1, in which the personal document is a benefit statement, a pension statement or other form of important notification.

4. The method according to claim 1, in which the personal information is selected from a group which includes salary, taxed income, profession, age, sex, pension contribution and postcode of the intended recipient.

5. The method according to claim 1, in which the promotional information is personalized to the recipient.

6. The method according to claim 1, further comprising the step of receiving internal communications or promotional information from the first source for inclusion in the personal document.

7. The method according to claim 1, in which the internal communication or internal promotional information is selected in dependence on the personal information.

8. The method according to claim 1, in which the step of selecting the recipient comprises the step of allocating the recipient to one or more advertising sources for the purpose of determining which promotional information is to be included in the personal document.

9. The method according to claim 8, in which the allocation step is mediated by an allocation strategy.

10. The method according to claim 1, further comprising a reservation step in which an advertising source can place one or more reservations for particular groups of recipients who have been selected for particular targeted advertising.

11. The method according to claim 10, in which the reservation step is mediated by a reservation strategy.

12. The method according to claim 1, further comprising a query step in which an advertiser may place a query with the service provider to determine whether a suitable target audience exists based on their chosen criteria.

13. The method according to claim 12, in which a response to the query comprises aggregate information in which the identity and details of potential recipients remain undisclosed.

14. The method according to claim 12, in which the query step is mediated by a search strategy.

15. The method according to claim 1, further comprising the step of compiling a database of information relating to the recipients of the personal documents and pertinent to the needs of potential advertisers.

16. The method according to claim 12, in which the personal document is generated in electronic form.

17. A personal document providing service which implements the method according to any preceding claim.

18. A computer-implemented engine for managing a personal document providing service comprising:
an interface for receiving personal information from a first source for inclusion in a personal document, the personal information concerning an intended recipient of the personal document;
an interface for receiving promotional information from a second source; and,
a processing system adapted to select the personal document recipient for receiving promotional information from the second source in dependence on the personal information, the processing system further adapted to generate personal information data and promotional information data for producing the personal document.

19. The engine according to claim 18, in which the interface for the second source is adapted to receive recipient selection data from the second source.

20. The engine according to claim 18, further comprising an interface for receiving preference data from the personal document recipient.

21. The engine according to claim 18, in which the engine interface is web enabled allowing operations via the internet.

22. The engine according to claim 18, in which the processing system of the engine is further adapted to execute query, reservation and allocation processes mediated by corresponding search, reservation and allocation strategies.

23. The engine according to claim 18, in which the engine is coupled to a database storing personal and preference information relating to the intended personal document recipients.
